(19) United States
(12) Patent Application Publication
(10) Pub. No.: US 2009/0109114 A1
(43) Pub. Date: Apr. 30, 2009

(54) Antenna structure

(75) Inventor: Steven YANG, Taipei Hsien (TW)

Correspondence Address: BACON & THOMAS, PLLC, 625 SLATERS LANE, FOURTH FLOOR, ALEXANDRIA, VA, 22314-1176, US

(73) Assignee: MICON PRECISE CORPORATION, Taipei Hsien (TW)

(21) Appl. No.: 11/976,799

(22) Filed: Oct. 29, 2007

(51) Int. Cl. H01Q 9/30; H01Q 1/52

(52) U.S. Cl. 343/841; 343/900

(57) ABSTRACT

An antenna structure includes a first tubing module, a second tubing module, an insulating tubing, a coaxial cable, an insulating tube and a base. Both ends of the insulating tubing are connected with the first and second tubing modules respectively. An interval is maintained between two corresponding ends connected with the tubing modules. The first tubing module is connected to the insulating tube, and the insulating tube is connected the base. The coaxial cable includes a central conductor and a metal conducting mesh, and the central conductor is connected the second tubing module, and the second tubing module is connected to a terminal inside the base. The metal conducting mesh is connected to the first tubing module, and the first tubing module is connected the base, so that the antenna structure can be operated at a specific frequency range and gives a better gain.

### FIELD OF THE INVENTION

The present invention relates to an antenna structure, and more particularly to an antenna structure that comes with a simple design to facilitate its mass production.

### BACKGROUND OF THE INVENTION

Cable network architecture at early stage used physical wires such as twist paired cables and coaxial cables, etc for connection, so that users can plan for a layout of network lines in compliance with available spaces of the environment, and it is necessary to maintain the network lines from time to time. In addition, users have to immediately rearrange the layout of network lines, whenever there is a change of spaces in the environment of the cable network, and thus causing tremendous trouble and inconvenience to users of a cable network. As wireless network advances from the early IEEEE 802.11 protocol to the recent 802.11a/b/g protocols, the transmission rate of the wireless network becomes increasingly faster, and the transmission technology such as direct sequence spread spectrum and frequency hopping spread spectrum, etc becomes more comprehensive, so that the applications of wireless networks become more diversified. For example, wireless electronic products including computers, electric appliances, audio/video equipments or communication equipments transmit data via a wireless network, and thus cable network is gradually replaced by wireless network. In general, a wireless electronic product transmits data by wireless waves transmitted via an antenna, and the antenna is used as a transmission and communication medium. Since the wireless waves come with a strong penetrating power, and the transmission is not limited to any specific direction, wireless electronic products simply require an antenna to construct a wireless network and a wireless data transmission environment, so as to overcome the drawbacks of the layout of network lines for the cable networks.

In recent years, most antenna structures of the wireless electronic products use a chip antenna or a printed circuit monopole antenna, wherein the chip antenna is usually manufactured by a low temperature co-fired ceramic (LTCC) technology. The LTCC technology adopts a ceramic material as the substrate, builds a plurality of low-capacitance passive components such as capacitors and resistors, etc in a multi-layer ceramic substrate, and co-fires a low-impedance metal such as gold, silver and copper, etc into an electrode, and finally forms an integrated ceramic component after going through a sintering process. However, the modulated components cannot be cut. If there is a change of circuit in the product design, another production is required, and the issue of unable to control the shrinking rate in a manufacturing process due to the ceramic firing process, and thus resulting an increase of defective rate during the production of chip antennas, and incurring a higher production cost to manufacturers.

Printed circuit monopole antenna is made by printing a microstrip line on a circuit board, but different circuit boards come with different circuit layout spaces, so that manufacturers need to have different designs of antenna circuits to fit the circuit board. Furthermore, the coefficients of the circuit between the circuit board and the antenna will be changed and the manufacturers have to redesign the antenna, if the manufacturers change a version of the circuit board or add or remove a component of the circuit board. As a result, an extra burden of manufacturing costs will be imposed on the manufacturers.

In addition to the issue of a difficult manufacturing process, the aforementioned two types of antennas still have the shortcomings of poor bandwidth and performance, so that these antennas cannot satisfy a consumer's requirements of wireless transmissions. Therefore, finding a way of designing an antenna with a high-speed transmission and an easy manufacture becomes a major subject for antenna manufacturers and an object of the present invention.

### SUMMARY OF THE INVENTION

In view of the shortcomings of the prior art antennas, the inventor of the present invention based on years of experience in the related industry to conduct extensive researches and experiments, and finally developed an antenna structure with a ultra wideband omni-directional antenna, and the manufacturing procedure of the antenna is simple and appropriate for its mass production, and thus the invention is valuable for industrial applications.

It is a primary objective of the present invention to provide an antenna structure, comprising a first tubing module, a second tubing module, an insulating tubing, a coaxial cable, an insulating tube and a base, wherein both ends of the insulating tubing are sheathed with the first tubing module and the second tubing module respectively, and an interval is maintained between two corresponding ends sheathed with the tubing modules, and another end of the first tubing module is connected with an internal periphery of the insulating tube, and an external periphery of the insulating tube is connected to an end of the base, such that the insulating tube can separate the base with the first tubing module to prevent a short circuit produced between the base and the first tubing module. The coaxial cable includes a central conductor and a metal conducting mesh, and an end of the central conductor is connected to an end of the second tubing module, and another end is extended and passed sequentially through the insulating tubing, the first tubing module, the insulating tube and the base, and connected with a terminal installed in the base, and the metal conducting mesh is connected to an end of the first tubing module, and another end is connected into the base, so that each component of the antenna structure can be produced with a modulation due to its simple design. Furthermore, it is not necessary to redesign the antenna structure to a great extent when a component is changed, and thus the antenna structure in accordance with the invention is very suitable for mass production.

Another objective of the present invention is to provide the first tubing module composed of a first hollow tube and a first circular tube, and the second tubing module composed of a second hollow tube and a second circular tube, and thus antenna manufacturers can change the interval between two corresponding ends of the first tubing module and the second tubing module to control the impedance matching of a baseband resonance mode and a high frequency resonance mode, and individually change the length and radius of the first hollow tube, the first circular tube, the second hollow tube or the second circular tube to control the frequency range of the electromagnetic coupling resonance mode, so that the antenna structure can achieve a broader scope of applications.

To make it easier for our examiner to understand the objective, technical characteristics and effects of the present invention, preferred embodiments will be described with accompanying drawings as follows.

### BRIEF DESCRIPTION OF THE DRAWINGS

FIG. 1 is an exploded view of an antenna structure;

FIG. 2 is a section view of an overall antenna structure;

FIG. 3 is a section view of connecting a tubing module of an antenna structure;

FIG. 4 is a section view of connecting a base of an antenna structure;

FIG. 5 is an exploded view of a base of an antenna structure base;

FIG. 6 is a schematic view of an antenna structure operated at 3.1 GHz;

FIG. 7 is a schematic view of an antenna structure operated at 4.9 GHz; and

FIG. 8 is a schematic view of an antenna structure operated at 3.1˜4.9 GHz.

### DETAILED DESCRIPTION OF THE PREFERRED EMBODIMENTS

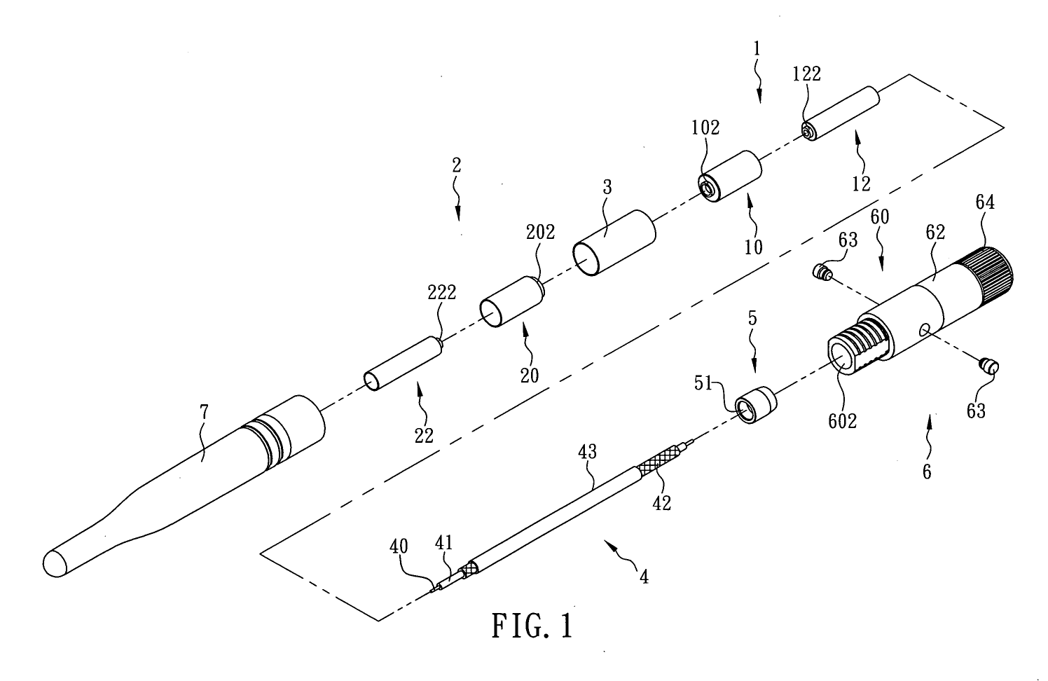

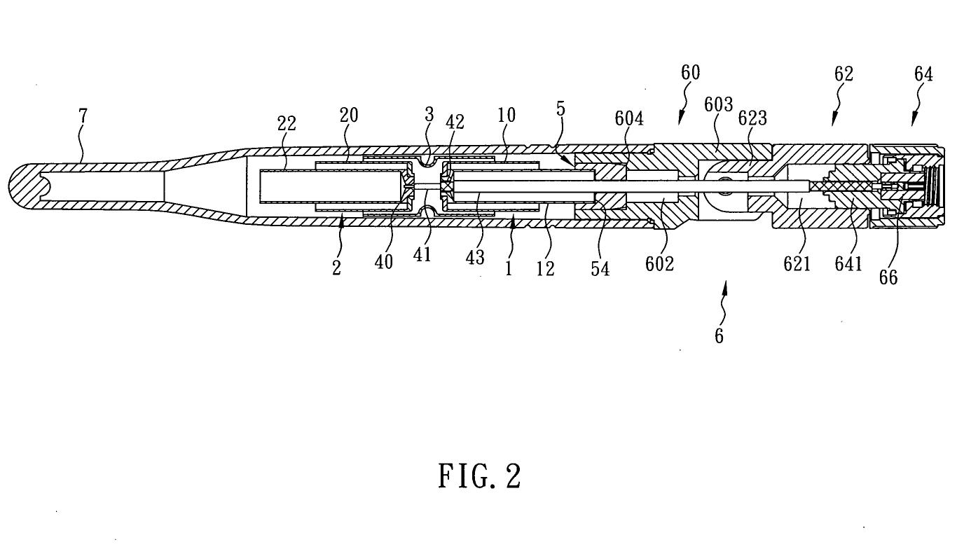

Referring to FIGS. 1 and 2 for an antenna structure of the present invention, the antenna structure comprises a first tubing module 1, a second tubing module 2, an insulating tubing (or a heat shrink tubing) 3, a coaxial cable 4, an insulating tube 5 and a base 6, wherein both ends of the insulating tubing 3 are connected with the first tubing module 1 and the second tubing module 2 respectively, and an interval is maintained between two corresponding ends connected with the tubing modules 1, 2, and another end of the first tubing module is connected to an internal periphery of the insulating tube 5, and an external periphery of the insulating tube 5 is connected to an end of the base 6. Further, the coaxial cable 4 includes a central conductor 40 and a metal conducting mesh 42, and an end of the central conductor 40 is connected to an end of the second tubing module 2, and another end is connected to a terminal 66 inside the base 6, and the metal conducting mesh 42 is connected to an end of the first tubing module 1, and another end is connected into the base 6, so that the antenna structure can be operated at a specific frequency range and gives a better gain. Further, the design of each component is simple, so that the antenna can be produced in modulation, and there is no need of redesigning the antenna structure to a great extend if it is necessary to change a component. Obviously, the antenna structure in accordance with the present invention is very suitable for mass production.

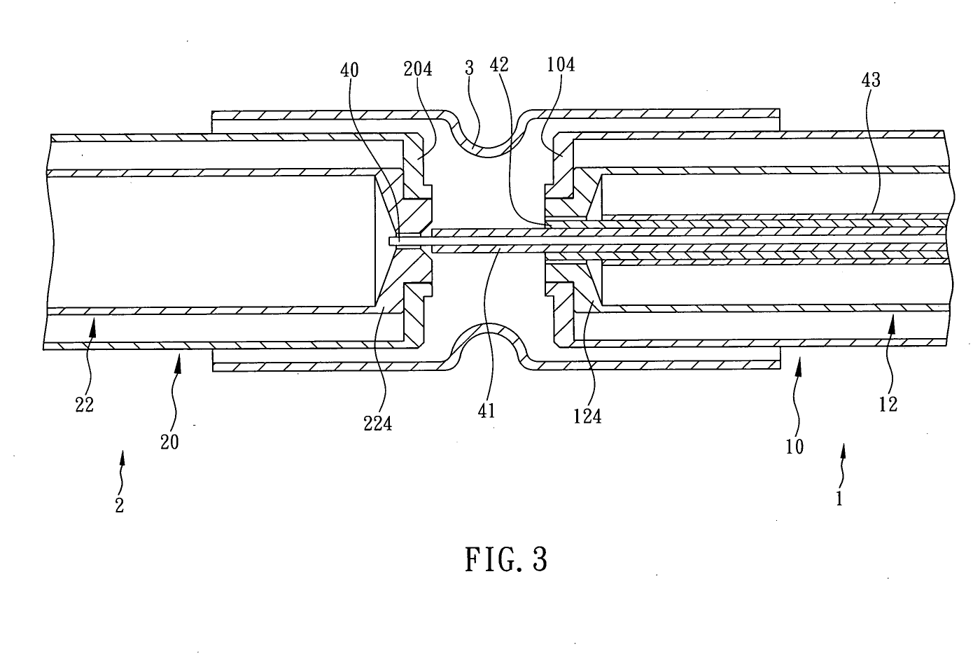

Referring to FIGS. 1 to 3 for a preferred embodiment of the present invention, the first tubing module 1 is formed by sheathing a first hollow tube 10 onto a first circular tube 12, wherein the middle of an end of the first hollow tube 10 has a first protruding ring 102, and a first shoulder 104 is formed between an external wall of the first protruding ring 102 and an external wall of the first hollow tube 10, and the first circular tube 12 has a second protruding ring 122 disposed at the middle of an end corresponding to the first hollow tube 10 122, and a second shoulder 124 is formed between an external wall of the second protruding ring 122 and an external wall of the first circular tube 12, and an external periphery of the second shoulder 124 abuts an internal periphery of the first shoulder 104.

Further, an end of the metal conducting mesh 42 is connected into the second protruding ring 122, and external layer of the metal conducting mesh 42 further includes an insulating outer jacket 43, such that when the metal conducting mesh 42 is conducted electrically, the isolation of the insulating outer jacket 43 can avoid a direct contact of the antenna structure with other components to prevent a short circuit caused by an electric current path between the metal conducting mesh 42 and the antenna structure.

The second tubing module 2 is composed of a second hollow tube 20 sheathed onto a second circular tube 22, wherein the second hollow tube 20 has a third protruding ring 202 disposed at the middle of an end corresponding to the first tubing module 1, and a third shoulder 204 is formed between the third protruding ring 202 and an external wall of the second hollow tube 20, and the second circular tube 22 has a fourth protruding ring 222 disposed at the middle of an end corresponding to the second hollow tube 20, and a fourth shoulder 224 is formed between the fourth protruding ring 222 and an external wall of the second circular tube 22, and an external periphery of the fourth shoulder 224 abuts an internal periphery of the third shoulder 204.

Further, an end of the central conductor 40 is connected into the fourth protruding ring 222, and the central conductor 40 and the metal conducting mesh 42 are isolated and insulated by an isolating layer 41, such that when the central conductor 40 is conducted electrically, the isolation of the isolating layer 41 can avoid a direct contact with the metal conducting mesh 42 to prevent a short circuit caused by an electric current path between the central conductor 40 and the metal conducting mesh 42.

In the preferred embodiment of the invention as shown in FIGS. 1 and 2, both ends of the insulating tubing 3 are sheathed with the first tubing module 1 and the second tubing module 2 respectively, not only maintaining a fixed distance between the first tubing module 1 and the second tubing module 2, but also connecting the first tubing module 1 and the second tubing module 2 more securely to avoid the isolating layer 41 between the fixed distance from being bent or damaged, which may further damage the central conductor 40 wrapped by the isolating layer 41.

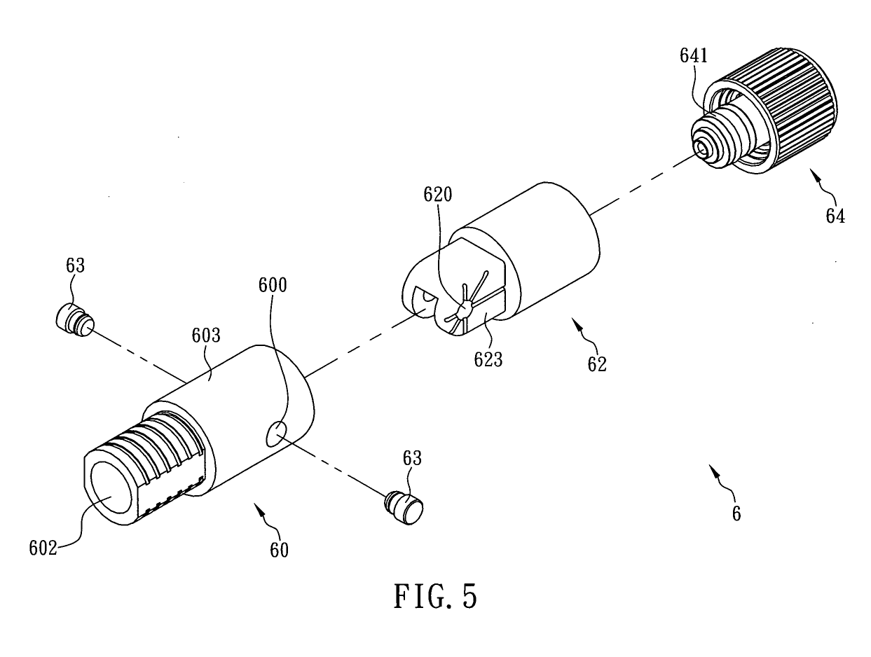

In the preferred embodiment of the present invention as shown in FIGS. 2 and 5, the base 6 is comprised of a connecting unit 60, a pivotal connecting unit 62 and a connector 64, and the connector 64 can accommodate the terminal 66, and an end of the connector 64 has a protruding pillar 641 substantially in the form a of a screw thread, and the pivotal connecting unit 62 has a recession 621 disposed at an end facing the connector 64, and the recession 621 is engaged with the protruding pillar 641, and another end of the pivotal connecting unit 62 has a first pivotal connecting portion 623, and both sides of the first pivotal connecting portion 623 have corresponding first through holes 620, and an end of the connecting unit 60 has a second pivotal connecting portion 603, and both sides of the second pivotal connecting portion 603 have a second through hole 600 corresponding to the first through hole 620, and the second pivotal connecting portion 603 can be covered onto the exterior of the first pivotal connecting portion 623, and a plurality of insert pins 63 are passed through the through holes 600, 620 sequentially, so that the connecting unit 60 and the pivotal connecting unit 62 are pivotally coupled with each other, and users can turn the pivotally connected connecting unit 60 and pivotal connecting unit 62 to adjust an angle of the antenna structure, so as to keep the antenna structure in the best condition of receiving signals.

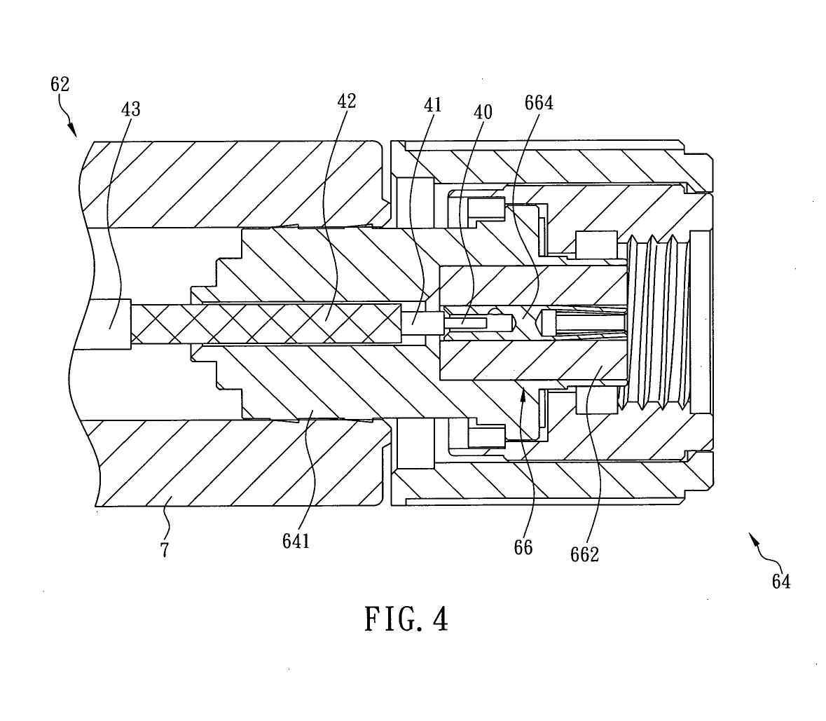

In a preferred embodiment as shown in FIG. 4, the terminal 66 includes a shielding layer 662 and a conducting layer 664, and the shielding layer 662 is made of an insulating material (such as rubber and plastic) and covered onto an external periphery of the conducting layer 664, and an end of the conducting layer 664 is connected to the central conductor 40, and another end of the metal conducting mesh 42 is connected to the protruding pillar 641, and the shielding layer 662 is non-conductive, and the conducting layer 664 is not connected to the connector 64, so that when the coaxial cable 4 is conducted electrically, a short circuit caused by a current path between the protruding pillar 641 and the terminal 66 can be prevented.

IN FIGS. 1 and 2, another end of the connecting unit 60 includes a first concave edge portion 602 embedded into the insulating tube 5, and a fifth shoulder 604 disposed at a position on its internal periphery and proximate to an end of the insulating tube 5, and the fifth shoulder 604 abuts the insulating tube 5, for fixing and embedding the insulating tube 5 into the first concave edge portion 602, and another end of the insulating tube 5 includes a second concave edge portion 51, and an internal diameter of an the second concave edge portion 51 is larger than the coaxial cable 4, and a sixth shoulder 54 is formed between an internal periphery of the second concave edge portion 51 and a position proximate to the coaxial cable 4, and an end of the first circular tube 12 is embedded into the second concave edge portion 51 and abuts the sixth shoulder 54, such that when the metal conducting mesh 42 is conducted electrically, the first circular tube 12 connected to the metal conducting mesh 42 is used for isolating the insulating tube 5 and the base 6, so as to completely avoids a short circuit caused by a current path between the first tubing module 1 and the base 6.

In the preferred embodiment as shown in FIG. 1, the antenna structure further comprises a cap cover 7 sheathed onto another end of the base 6 and covered onto the first tubing module 1, the second tubing module 2, the insulating tubing 3 and the insulating tube 5, such that the cap cover 7 can achieve the covering and dust preventing effects for the covered portion of the antenna structure, so as to prevent affecting the operation performance of the antenna structure when other components are touched by accident when the tubing modules 1, 2 are operated or due to the accumulation of dusts.

It is noteworthy to point out that the shape and size of the cap cover can be changed according to the actual requirements of the antenna structure. Any cap cover 7 can be used as long as the first tubing module 1, the second tubing module 2, the insulating tubing 3 and the insulating tube 5 can be covered to achieve the covering and dust preventing effects.

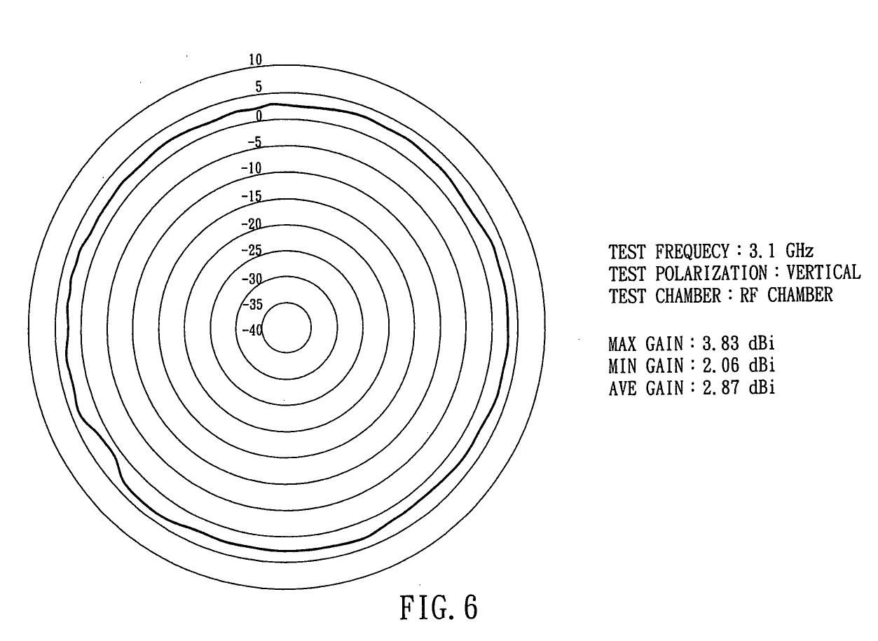

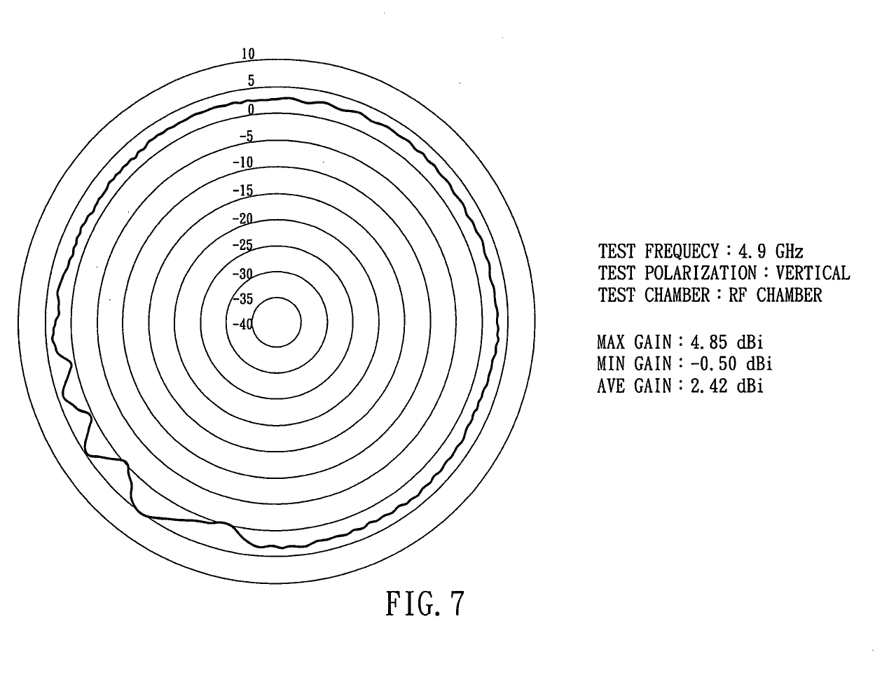

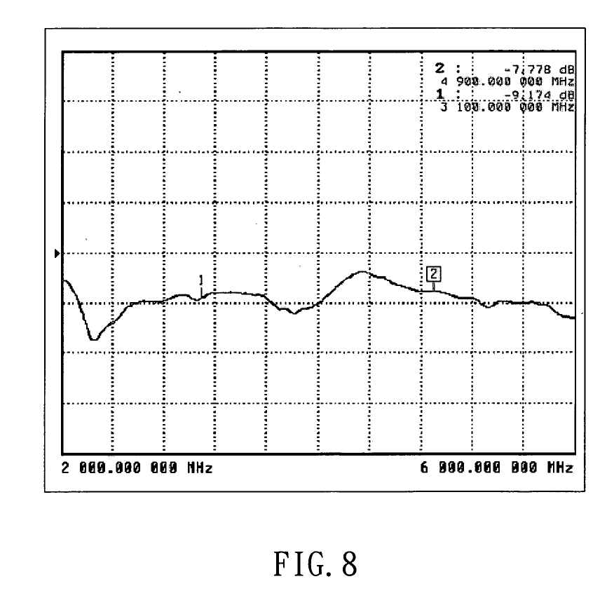

The antenna structure in accordance with a preferred embodiment of as shown in FIGS. 1 and 2 is tested. In FIG. 6, if the antenna structure is operated at 3.1 GHz, the maximum gain can be up to 3.83 dBi, and the average gain can be 2.87 dBi, and thus the antenna structure can be operated at this frequency range, and becomes an omni-directional antenna. Further, the inventor of the invention performs another test for the antenna structure as shown in FIGS. 1 and 2. In FIG. 7, if the antenna structure is operated at 4.9 GHz, the maximum gain can be up to 4.85 dBi, and the average gain is 2.42 dBi, and thus the antenna structure can be operated at this frequency range, and becomes an omni-directional antenna. In FIG. 8, if the antenna structure is operated a 3.1 GHz˜4.9 GHz, the return loss approaches −10 dB, and thus it approaches a predetermined matching value, and the antenna structure can be used for ultra wide bands.

While the invention has been described by means of specific embodiments, numerous modifications and variations could be made thereto by those skilled in the art without departing from the scope and spirit of the invention set forth in the claims.

What is claimed is:

1. An antenna structure, comprising:
a first tubing module, having a first hollow tube and a first circular tube, and
the first hollow tube being sheathed onto the first circular tube;
a second tubing module, having a second hollow tube and a second circular tube, and the second hollow tube being sheathed onto the second circular tube;
an insulating tubing, with both ends respectively coupled to the first hollow tube and the second hollow tube, and the hollow tubes maintaining an interval between both ends that are coupled with the insulating tubing;
an insulating tube, with an internal periphery coupled to another end of the first tubing module;
a base, having a terminal disposed at an end of the base, and another end of the base being coupled to an external periphery of the insulating tube; and
a coaxial cable, including a central conductor and a metal conducting mesh, and an end of the central conductor being coupled to an end of the second tubing module, and another end being coupled to the terminal, and the metal conducting mesh being coupled to an end of the first tubing module, and another end being coupled into the base.

2. The antenna structure of claim 1, wherein the first circular tube includes a second protruding ring disposed at an end of the first circular tube, and coupled with the metal conducting mesh.

3. The antenna structure of claim 1, wherein the second circular tube includes a fourth protruding ring disposed at an end of the second circular tube and coupled with the central conductor.

4. The antenna structure of claim 1, wherein the first hollow tube includes a first shoulder disposed at an end of the first hollow tube, and the first circular tube includes a second shoulder disposed at an end of the first circular tube, and an external periphery of the second shoulder abuts an internal periphery of the first shoulder.

5. The antenna structure of claim 1, wherein the second hollow tube includes a third shoulder disposed at an end of the second hollow tube, and the second circular tube includes a fourth shoulder disposed at an end of the second circular tube, and an external periphery of the fourth shoulder abuts an internal periphery of the third shoulder.

6. The antenna structure of claim 1, wherein the base comprises:
a connector, having a protruding pillar disposed at an end of the connector, and the protruding pillar being in a thread form, for accommodating the terminal;
a pivotal connecting unit, having a recession disposed at an end of the pivotal connecting unit, and the recession being engaged with the protruding pillar, and the pivotal connecting unit includes a first pivotal connecting portion disposed at another end of the pivotal connecting unit, and the first pivotal connecting portion includes a first through hole disposed on both corresponding sides of the first pivotal connecting portion; and
a connecting unit, including a second pivotal connecting portion at an end of the connecting unit, and the second pivotal connecting portion having a second through hole separately disposed on both sides of the second pivotal connecting portion and corresponding to the first through hole, and the second pivotal connecting portion being covered onto the exterior of the first pivotal connecting portion, and a plurality of insert pins being passed sequentially into the through holes, such that the second pivotal connecting portion and the first pivotal connecting portion are pivotally coupled with each other.

7. The antenna structure of claim 6, wherein the connecting unit includes a first concave edge portion disposed on another end of the connecting unit, and the first concave edge portion includes a fifth shoulder abutting an end of the insulating tube.

8. The antenna structure of claim 7, wherein the insulating tube includes a second concave edge portion disposed on another end of the insulating tube, and the second concave edge portion includes a sixth shoulder disposed therein and abutting another end of the first circular tube.

9. The antenna structure of claim 6, wherein the terminal comprises:
a conducting layer, with an end coupled with the central conductor, and another end not coupled with the base; and
a shielding layer, covered onto the shielding layer, and being made of an insulating material.

10. The antenna structure of claim 6, wherein the metal conducting mesh is coupled with the protruding pillar.

11. The antenna structure of claim 1, further comprising a cap cover, coupled to another end of the base, and covered onto the tubing modules, the insulating tube and the insulating tubing.
